(19) United States
(12) Patent Application Publication
(10) Pub. No.: US 2026/0036240 A1
(43) Pub. Date: Feb. 5, 2026

(54) ACCESS FITTING FOR A DRAIN LINE

(71) Applicant: James M. Truitt, Claremore, OK (US)

(72) Inventor: James M. Truitt, Claremore, OK (US)

(21) Appl. No.: 18/935,137

(22) Filed: Nov. 1, 2024

Related U.S. Application Data
(60) Provisional application No. 63/595,107, filed on Nov. 1, 2023.
(60) Provisional application No. 63/619,630, filed on Jan. 10, 2024.

(51) Int. Cl. F16L 55/115

(52) U.S. Cl. CPC F16L 55/1152

(57) ABSTRACT

A stub out fitting of this disclosure includes female threads for receiving a temporary cap and may be configured as a tee or as a 90 for either spigot or hub applications. Embodiments of this disclosure eliminate the need for advanced planning by a plumber at the rough-end stage of construction and the need for skilled work at the finish-end stage to produce a professional, attractive-looking spigot or hub installation. When using a stub out fitting of this disclosure, the plumber simply makes a choice, at the finish-end stage, between a tubular p-trap or PVC DWV p-trap when connecting to all sinks, drinking fountains and, on occasions, bathtubs. Adapters of this disclosure permit efficient connections of the stub out to fixtures such as service sinks, wall-hung urinals, or residential rear exit water closets.

### CROSS-REFERENCE TO CO-PENDING APPLICATIONS

This application claims priority to U.S. 63/595,107 filed Nov. 1, 2023 and U.S. 63/619,630 filed Jan. 10, 2024.

### BACKGROUND

This disclosure is in the field of plumbing couplings or fittings and, in particular, stub outs for use in spigot or hub applications and clean-out plugs and access fittings for use with drain lines in commercial and residential properties.

In new construction or remodeling, a stub out protrudes past the wall or millwork. With prior art stub outs, the plumber must plan at the rough-in stage the type of trap needed in the finish-stage. Where planning is poor, an unprofessional or unattractive installation results. And in cases where planning is proper, a lot of time and skill is needed to make the installation look professional and attractive.

It is common practice to have a plug recessed in wall or pipe chase to gain access to a drain and clear a stoppage. To unscrew the plug is a challenge because it is located within a small hole, may be back in the pipe chase 5 or 6 inches, and, if the plug has been in place for some time, it is seized up. Removal usually requires a chisel to beat out the plug.

Having a recessed plug in the wall is also problematic because of backed-up stoppage. When removing the plug, human waste escapes behind the walls or chase. There is no good way to clean up the mess and, therefore, at least some of it can get left behind after the initial drain cleaning. This can lead to mold build-up, rusting of metal stud walls, and a habitat for roaches.

There are also problems with the chrome clean-out covers used with the traditional, recessed clean-out plug. The screw that attaches the chrome plate to the plug is usually deteriorated. Once removed, it typically has to be replaced. The plumber may not have a screw long enough or the plumber does have a screw but it is too long. Cutting the screw to a proper length is not easy because there is no exact depth at which the plug is recessed in the wall. If the screw ends up too long, it can cause a stoppage as, for example, flushed toilet paper products catch on the screw. Buildup of paper and other waste continues on the screw and in the pipe as additional flushes are made.

Installing a recessed plug in new construction requires a drill to make a hole in the plug, a screw tap to make threads for the screw, and a hacksaw to cut the proper length screw so that the screw sits proud of the drywall to-be-installed. And sometimes in new construction the screw of the screwed-into plug is removed by the drywallers and the plug ends up getting covered by drywall. When this occurs, if the plumber has not taken measurements of the cleanout location in advance, the plumber then has to guess as to where the plug is and cut a hole in the wall to find it so that it can be trimmed out with the chrome cover.

### SUMMARY

A stub out fitting of this disclosure includes female threads for receiving a temporary cap and may be configured as a tee or as a 90 for either spigot or hub applications. Embodiments of this disclosure eliminate the need for advanced planning by a plumber at the rough-end stage of construction and the need for skilled work at the finish-end stage to produce a professional, attractive-looking spigot or hub installation. When using a stub out fitting of this disclosure, the plumber simply makes a choice, at the finish-end stage, between a tubular p-trap or PVC DWV p-trap when connecting to all sinks, drinking fountains and, on occasions, bathtubs. Adapters of this disclosure permit efficient connections of the stub out to fixtures such as service sinks, wall-hung urinals, or residential rear exit water closets.

An access fitting of this disclosure includes a coupling and a cap, the coupling adapted for connection to a stub-out pipe. Unlike prior art residential clean-out applications, there are no gaps around the fitting of this disclosure when drywalled or fitted to a cabinet back. Instead, the fitting sits flush against the finished wall or cabinetry and be caulked for proper sealing. Also, unlike the prior art clean-out or access fittings, with fittings of this disclosure there are no threads for the drain cable to drag across. Additionally, no tools will be required to remove the access fitting because it is hand tightened. A stub out fitting of this disclosure may be selected from group consisting of a tee, a 90, and a cross and includes an inlet end extending about 6 inches in length and having female threads at its distal end. The stub out fitting may further included a threaded cap adapted for engagement with the female threads. The threaded cap includes an o-ring so that leak or pressure testing of the piping system may be conducted.

In some embodiments, the stub out fitting includes an adapter fitting adapted for connection to the inlet end. The adapter fitting may have at least one unthreaded end. The adapter fitting may have wherein the adapter fitting has at least one male threaded end. A female threaded cap is adapted for engagement with the at least one male threaded end. The adapter fitting may include a chain, with the adapter fitting and the female threaded cap each including a retention post to receive a corresponding end the chain.

The tee may have an inlet having a larger diameter and a drain and vent having a smaller diameter, the inlet including an inner curvature connecting the larger and smaller diameters. The 90 may include an eccentric inner diameter, wherein when the 90 is oriented in a horizontal plane, a central longitudinally extending axis of the inlet and outlet ends do not intersect one another. The 90 may be configured as a right- or left-handed 90.

### BRIEF DESCRIPTION OF THE DRAWINGS

FIG. 1 is a side elevation, partial cross-section view of a spigot stub out 90 of this disclosure. The inlet end includes female threads and a male-threaded cap with an o-ring, The cap, which is removed during the finish-end stage of construction, is adapted for hand tightening and permits leak testing of the piping system. The inlet end of the stub out extends about 6 inches in length.

FIG. 2 is a side elevation view of a hub 90 fitting of this disclosure connected to a piece of pipe that glues onto the outlet end of the hub 90 and the inlet end of a stub out. The hub 90 is configured here as a right-hand hub 90. In other embodiments, the hub 90 is configured as a left-hand hub 90. Unlike prior art 90s, includes an eccentric inlet relative to that of stub out. One reason for the eccentric design is to keep the flow line true. Another reason is T Another reason is the hub size is larger than the spigot size. The inlet end of the hub 90 includes female threads and extends about 6 inches in length (in a direction out of the page here).

FIG. 3A is a front elevation view of a spigot stub out tee of this disclosure that has an inlet end which extends about 6 inches in length and includes female threads.

FIG. 3B is a front elevation view of a hub stub out tee of this disclosure include a full size throat and an inlet end that extends about 6 inches in length and includes female threads. Because the hub size is larger than the spigot size, the inlet end of the tee is larger in diameter than the vent and drain ends. The contour of the fitting provides an acceptable restriction of flow in drainage fittings for use with a rear-exit water closet.

FIGS. 4A to 4E are views of a clean out of this disclosure having a female unthreaded end for insertion into, and gluing onto, the spigot inlet end and a male threaded end for connection to the cap. The spigot inlet end does not need to be cut off past the finished wall. In some embodiments, the clean out includes a male unthreaded end that goes over spigot inlet end. In other embodiments, the clean out includes a male threaded end.

FIGS. 5A to 5D are views of the clean out fitting of FIGS. 4A to 4E. The fitting may include a retention post for connection to a chain.

FIGS. 6A to 6D are views of the clean out cap of FIGS. 4A to 4E. The cap can be made with or without a retention post for the chain. Where a male thread end is included on the clean out, the clean out may be recessed in the wall and include a hex shoulder. The cap may also include a ¼ inch tapped hole located on its center to receive a screw for a chrome clean out cover.

FIGS. 7A to 7E are views of a prior art commercial grade lip clean out with a cap of this disclosure. The cap screws onto the male threads of the cleanout and includes flanges for use when hand tightening. When using the clean out, the spigot inlet end is cut about ¾ inch past the finished wall and the clean out is glued onto the spigot.

FIGS. 8A to 8D are views of the lip clean out of FIGS. 7A to 7E.

FIGS. 9A to 9D are views of the cap of FIGS. 7A to 7E. In some embodiments, the clean-out and cap each include a retention post for connection to a chain.

FIGS. 10A to 10E is another embodiment of a prior art commercial grade lip clean out with a cap of this disclosure. The clean-out and cap each include a retention post for connection to a chain.

FIG. 11A is a view of a builders-grade clean out with a low lip profile and including a cap of this disclosure. The cap includes a scalloped perimeter for hand tightening. In some embodiments, the cap does not include the retention post or the chain.

FIG. 11B is another embodiment of a builders-grade cleanout out with a low lip profile and a cap of this disclosure. In some embodiments, the cap includes a retention post and chain.

FIGS. 12A(1) to (12) & 12B(1) to (4) are side elevation views of a spigot stub out fitting of this disclosure. All of the fittings have a female thread on the inlet end and can be configured as size-on-size or in reducing sizes.

FIG. 12C(1) to (6) are side elevation views of embodiments of adapters of this disclosure for connection to a spigot inlet end.

FIG. 13A(1) to (11) are side elevation views of a hub stub out fitting of this disclosure. All of the fittings can be configured as size-on-size or in reducing sizes.

FIG. 13B(1) to (14) are side elevation views of embodiments of adapters of this disclosure for connection to a hub inlet end.

FIGS. 14A to 14E are views of an embodiment a lip trap adapter of this disclosure that glues onto a spigot inlet end and includes male threads and a nut for a tubular p-trap. The spigot inlet end is cut-off about ¾ inch past the finished wall and the lip trap adapter is glued onto it.

FIGS. 15A to 15D are views of the lip trap adapter fitting of FIGS. 14A to 14E.

FIGS. 16A to 16D are views of the lip trap adapter cap of FIGS. 14A to 14E.

FIGS. 17A to 17D are views of a low profile lip coupling of this disclosure that glues onto a spigot inlet end. The spigot inlet end is cut-off about ¾ inch past the finished wall and the low profile lip coupling is glued onto it.

FIG. 18 is a front elevation view of an embodiment of a cap for use with a coupling of this disclosure.

FIG. 19 is a top plan view of the cap of FIG. 18.

FIG. 20 is a bottom plan view of the cap of FIG. 18.

FIG. 21 is a view taken along section line 21-21 of FIG. 18.

FIG. 22 is a front elevation view of an embodiment of a coupling for use with a cap of this disclosure.

FIG. 23 is a top elevation view of the coupling of FIG. 22.

FIG. 24 is an exploded assembly view of the cap of FIG. 18 and the coupling of FIG. 22 arranged for connection to a drain pipe.

FIG. 25 is a view of an embodiment of an access fitting of this disclosure when in an assembled, installed state.

FIG. 26 is front elevation view of an embodiment of a trap adapter of this disclosure.

FIG. 27 is a bottom elevation view of the trap adapter of FIG. 26.

FIG. 28 is a top elevation view of the trap adapter of FIG. 26.

FIG. 29 is the trap adapter of FIG. 26 when installed on a tubular P-trap.

FIG. 30 is a front elevation view of an alternate embodiment of a cap of this disclosure.

FIG. 31is a top plan view of the cap of FIG. 30.

FIG. 32 is a bottom plan view of the cap of FIG. 30.

FIG. 33 is a cross-section view of the cap of FIG. 30.

### NUMBERING USED IN THE DRAWINGS

10 Stub out fitting (a tee, a 90, or a cross)
11 Inlet
13 Inlet end
15 Female threads
17 Male-threaded cap
19 O-ring
21 Adapter fitting
23 Unthreaded end
25 Male threaded
27 Female-threaded cap
29 Chain
31 Retention post or slot
33 Drain or outlet end
35 Vent end
37 Eccentric inner diameter
39 Central longitudinally extending axis of the inlet end
41 Central longitudinally extending axis of the outlet end
43 Outlet
45 Outlet end
47 Flange
49 Perimeter
51 Inner curved walls
53 Lip cleanout
55 Lip trap adapter
57 Low profile lip coupling

### DESCRIPTION

Embodiments of a stub out fitting of this disclosure eliminate the need for advanced planning by a plumber at the rough-end state and the need for skilled work at the finish-end stage to produce 5professional, attractive-looking spigot or hub installations. When using a stub out of this disclosure, the plumber simply makes a choice, at the finish-end stage, between a tubular p-trap or PVC DWV p-trap. The stub out may be configured as a tee or 90 for spigot or hub applications and include a female threaded end. A cap threads onto the end and permits plumbing code-required leak or pressure testing of the piping system. Other embodiments of a 90 of this disclosure include an eccentric design that prevents blockage along the line. Adapters of this disclosure permit connection to special fixtures such as service sinks, urinals, or residential rear exit water closets.

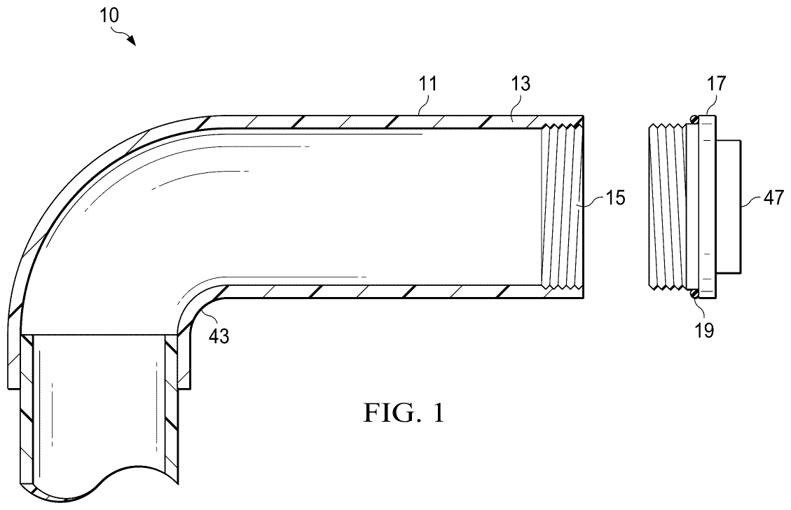

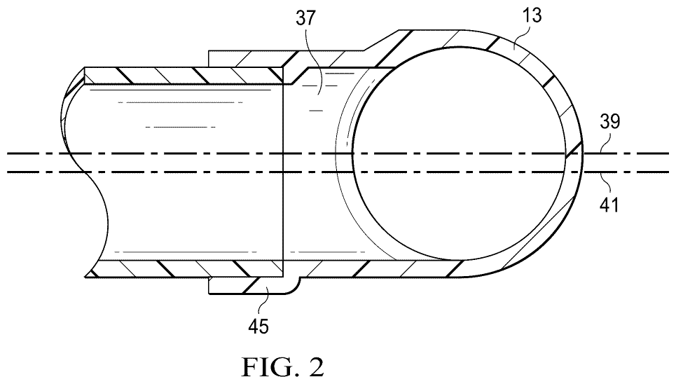

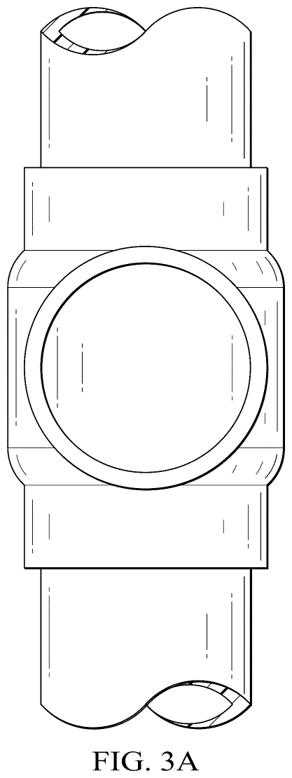

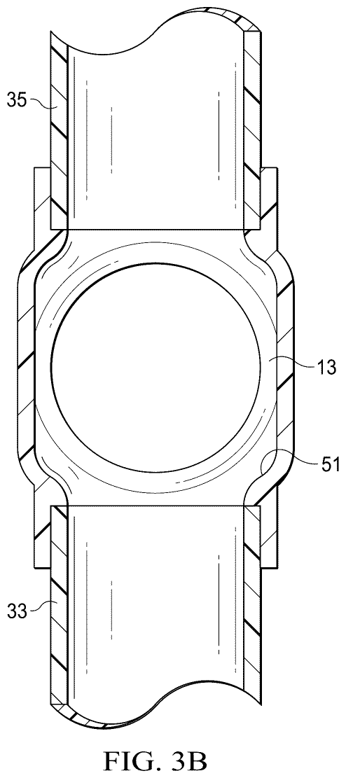

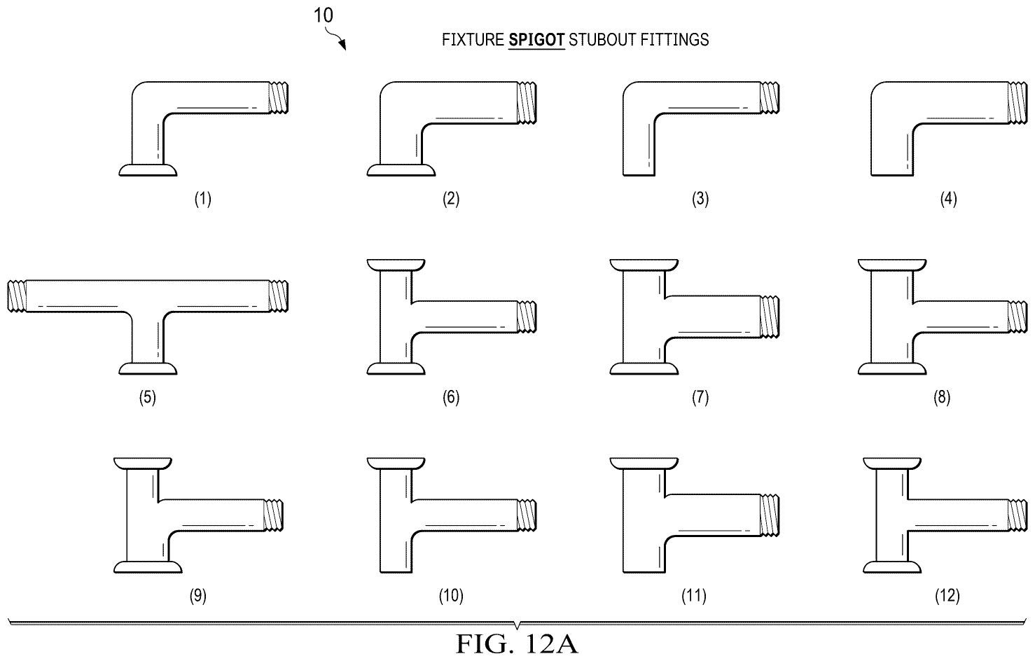

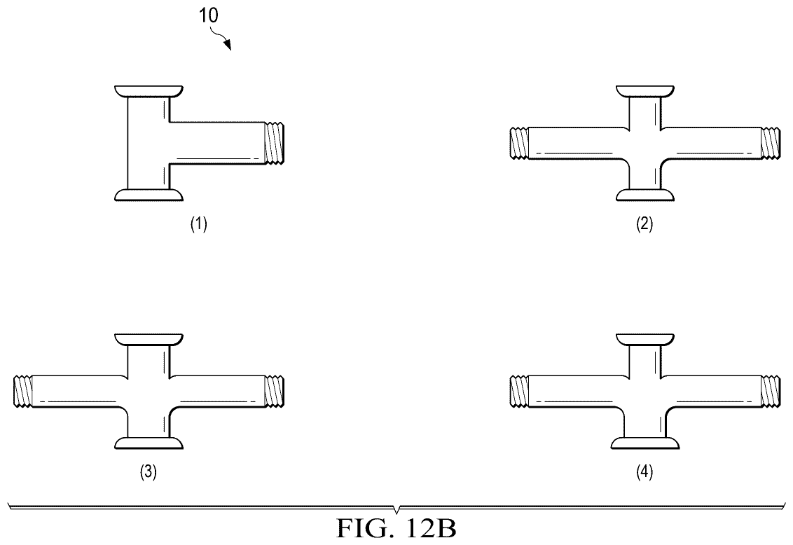

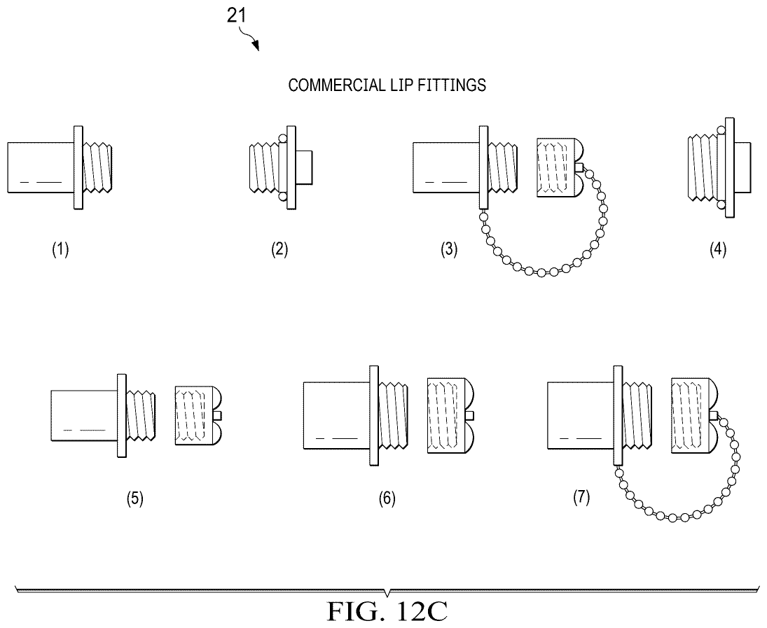

Referring to the drawings, and in particular FIGS. 1 to 3 and 12A to 13B, embodiments of a stub out of this disclosure include a tee fitting or a 90 fitting having a female threaded end for connection to a male threaded cap having an o-ring. The fitting may be configured for a spigot application (having a diameter of the 1½″ 2″ 3″ 4″ pipe to fit into a hub) or a hub application (a diameter of the hub being greater than the pipe). The cap permits plumbing code-required leak testing of the piping system.

A tee stub out of this disclosure includes a ⅛″ upgraded pitch to provide a gravity flow and prevent buildup of waste and eliminate stoppage. This pitch is not needed for 90 stub outs because each is installed in a horizontal plane and can be pitched during install. The inlet end of the tee includes female threads and extends about 6 inches in length.

In some hub tee embodiments of this disclosure, the inlet end of the tee is a larger diameter than that of the vent and drain ends. For example, the hub tee may be 2″×1½″×1½″, the larger size being the hub size, the smaller size being the spigot size. To ensure smooth flow, and remain within plumbing code requirements regarding flow restrictions, the tee includes inner curved walls.

In some embodiments, the fitting is configured as a sanitary cross fitting for use in either spigot or hub applications. The two inlet ends of the fitting include female threads.

Embodiments of a 90 stub out of this disclosure and intended for use in hub applications may be eccentric in design and configured as a left-handed fitting or a right-handed fitting. (No similar requirement is required in spigot applications.) Because a drainpipe is not always roughed-in in the center of the fixture, there must be a branch from the drainpipe right- or left-of-center depending on the position of the drainpipe in relation to the fixture. A continuous flow line must be created and any reduction in size can lead to an accumulation of waste and stoppage. Therefore, the 90 includes an eccentric inner diameter that provides a smooth transition and prevents blockage, the central longitudinally extending axis of the inlet and outlet ends not intersecting one another. Because the hub size is larger than that of the fixture size, the hub provides an inline vent, meaning more air is supplied for better draining (and further reducing the risk of waste accumulation). In some embodiments the 90 includes an enlarged throat diameter relative to the inlet or outlet diameters (or both).

With hub stub outs of this disclosure, when it is time to connect the drain to the fixture, the stub out pipe may be cut to any length past the finished wall or millwork. An escutcheon is then pushed over the pipe and slid to the finished wall or millwork to cover any unsightly hole. If the plumber prefers to use a tubular p-trap, the p-trap is glued onto the spigot end trap adapter with its shoulder into the inside of the stub out pipe. If the plumber wants to use a PVC DWV p-trap, the p-trap is glued in a reducing inside x inside coupling into the inside of the stub out pipe.

If the plumber wants to use the stub out for a cleanout, the plumber cuts off the stub out pipe and then glues a spigot end cleanout into the inside of the stub out pipe. In embodiments, spigot end with male threads can be used to connect special fixtures such as service sinks, wall-hung urinals, or residential rear exit water closets. In those applications, the plumber cuts off the stub out pipe and glues the spigot end with male threads, screws on a bracket, and sets the fixture. This method is simpler than prior art methods.

A spigot stub out of this disclosure may be used with a lip trap adapter or a lip coupling. A lip trap adapter of this disclosure glues onto a spigot inlet end and includes male threads and a nut for a tubular p-trap. The spigot inlet end is cut-off about ¾ inch past the finished wall and the lip trap adapter is glued onto it. Similarly, a low profile lip coupling of this disclosure glues onto a spigot inlet end, the spigot inlet end is cut-off about ¾ inch past the finished wall, and the low profile lip coupling is glued onto it.

The spigot stub out fittings permit a simpler approach to setting fixtures as well. With the spigot stub out, the plumber cuts the pipe about ¾″ past finished wall and glues a lip coupling, lip trap adapter, or lip cleanout, thereby allowing the plumber to use a tubular trap or a PVC DWV adjustable p-trap. For example, with a 1½″ spigot stub out the plumber can use a trap adapter of this disclosure to glue into the inside of the stub out pipe to allow connection to a lavatory or a drinking fountain, since these fixtures have 1¼″ connections. Or, an extension having a small diameter on one end glues into the hub stub out and a larger diameter on the other end glues onto the spigot pipe to extend to wherever needed for the trap. Or, male ends glue into the spigot and hub stub out on one end and a trap adapter on the other.

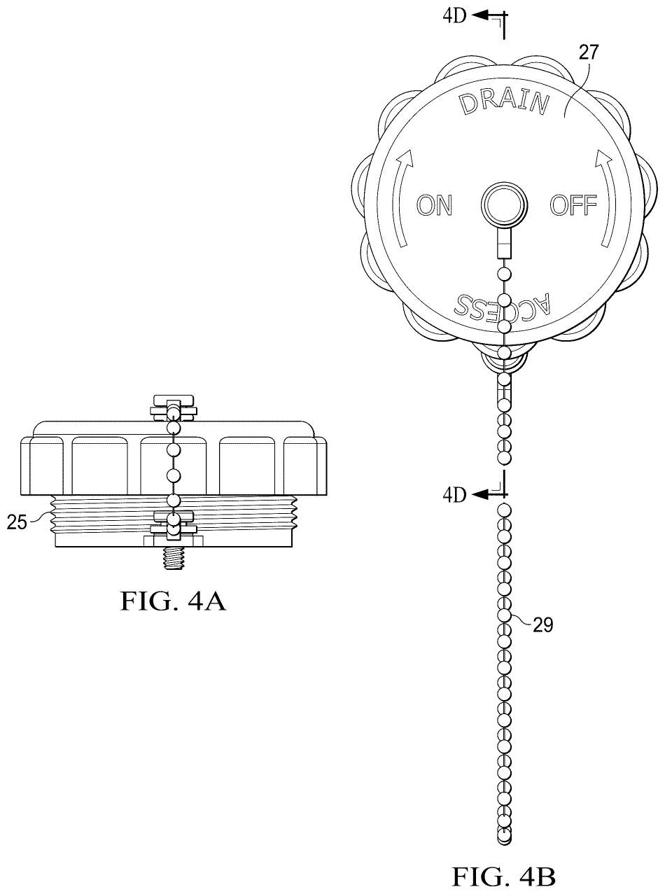

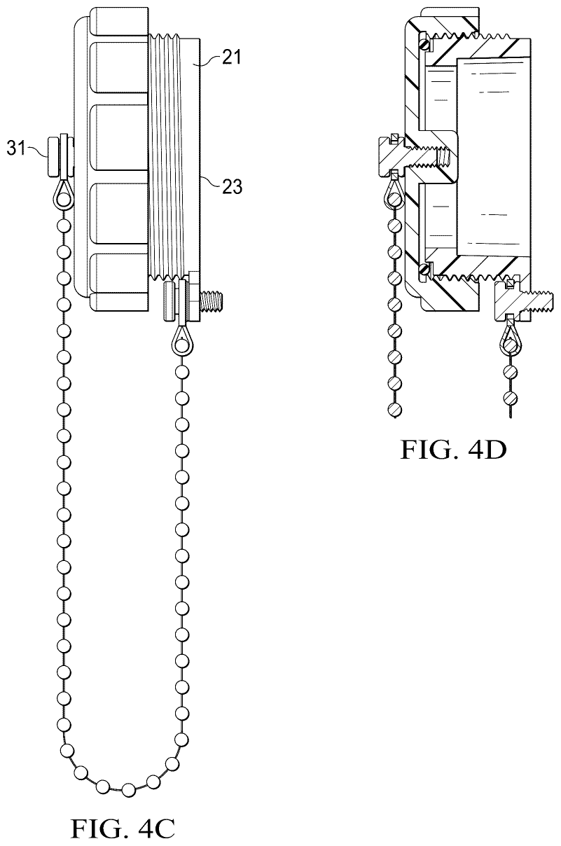

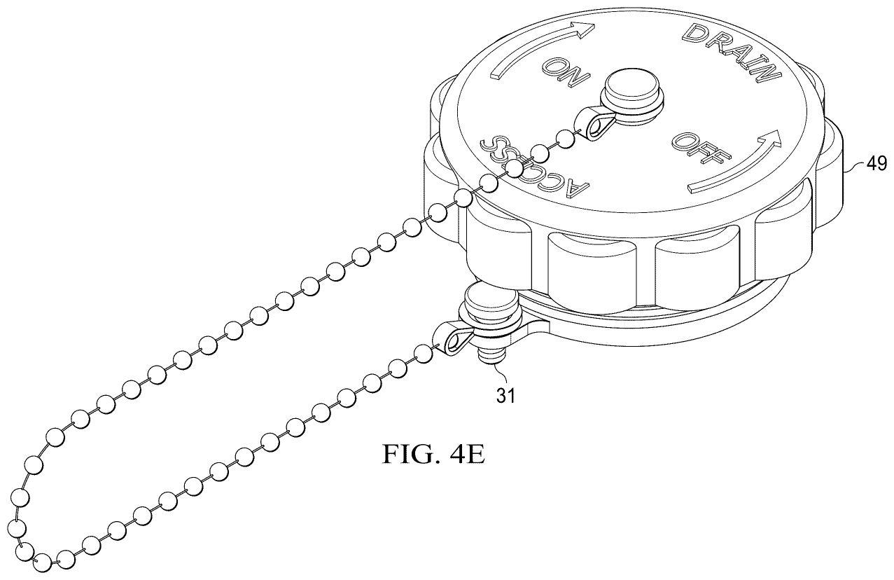

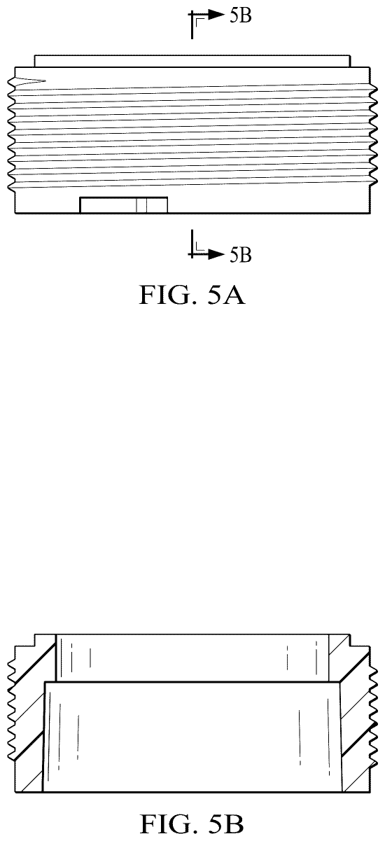

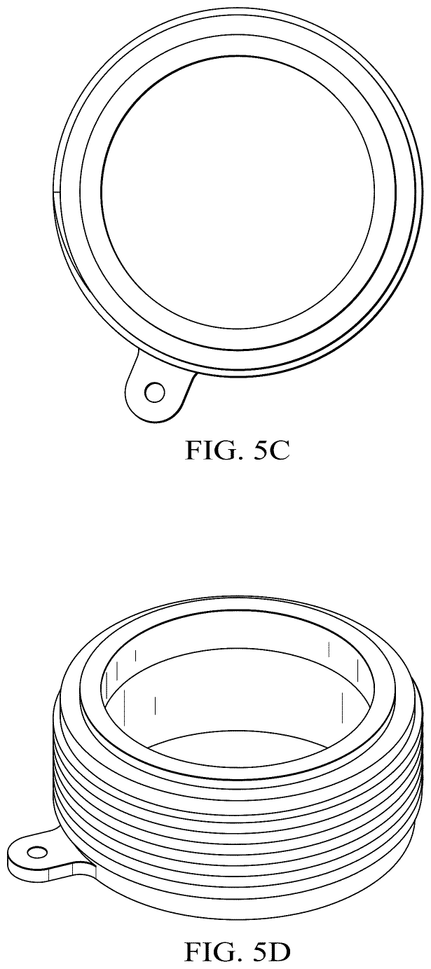

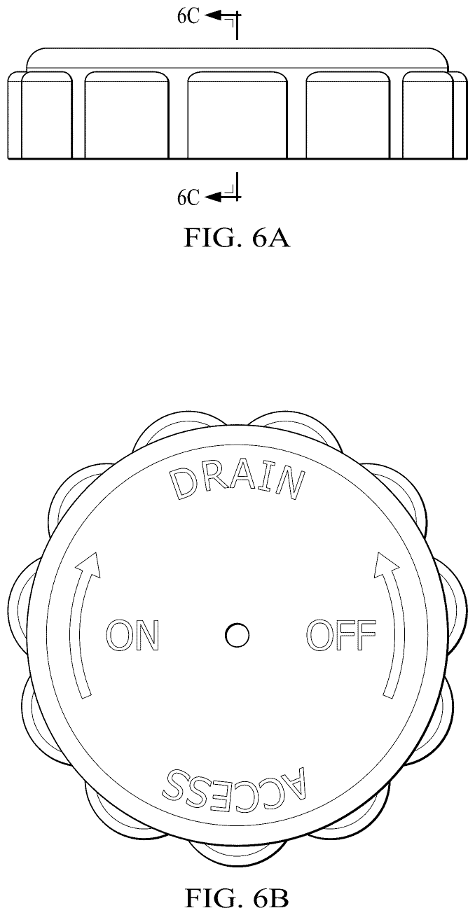

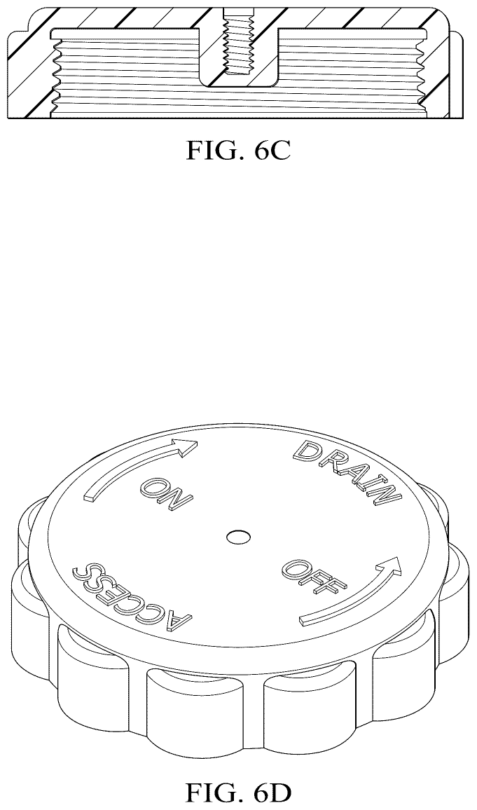

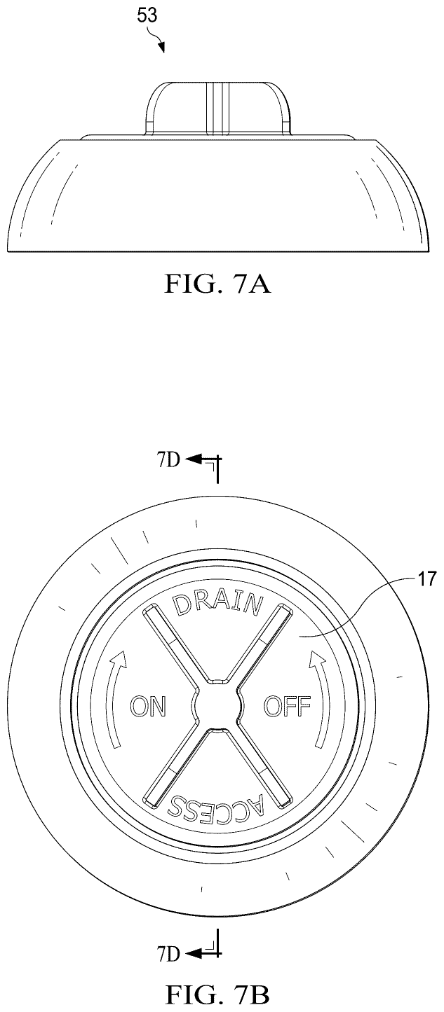

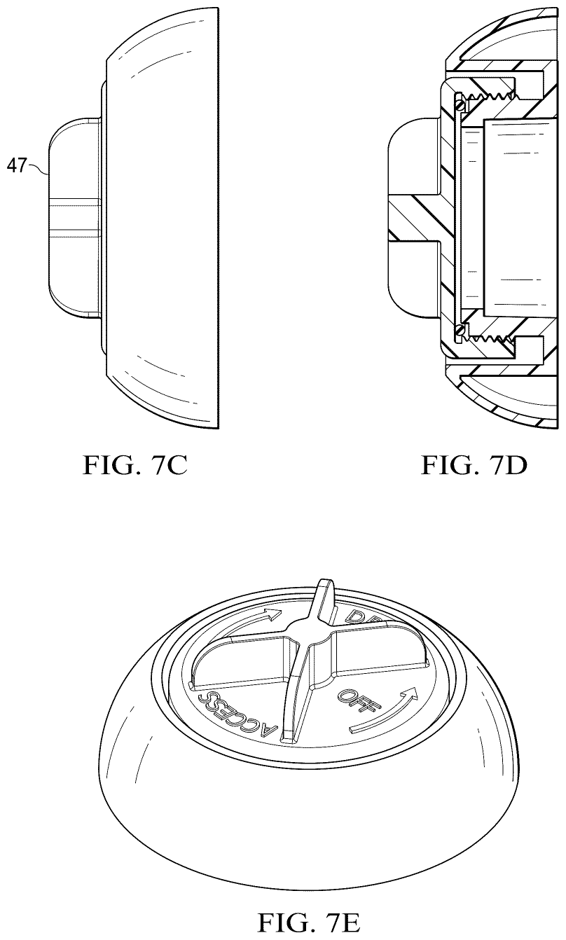

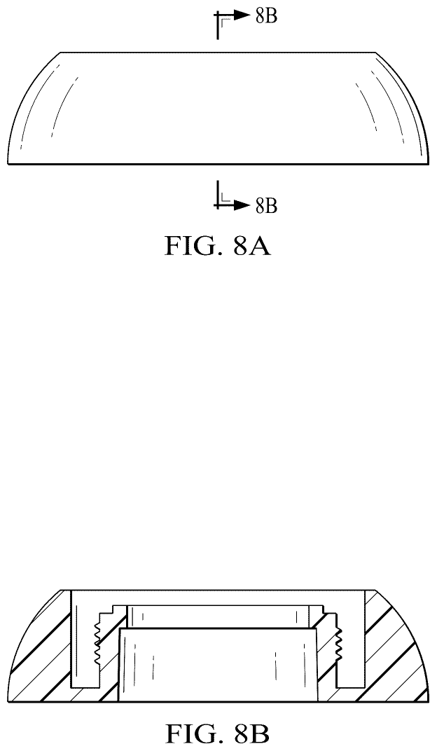

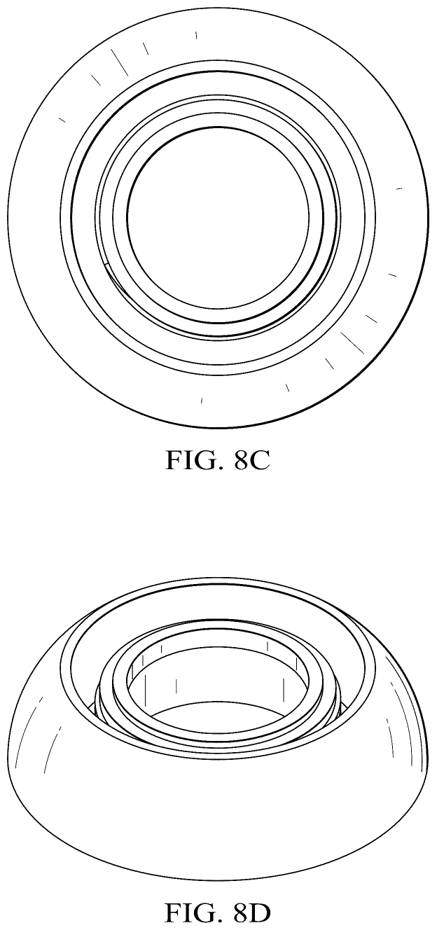

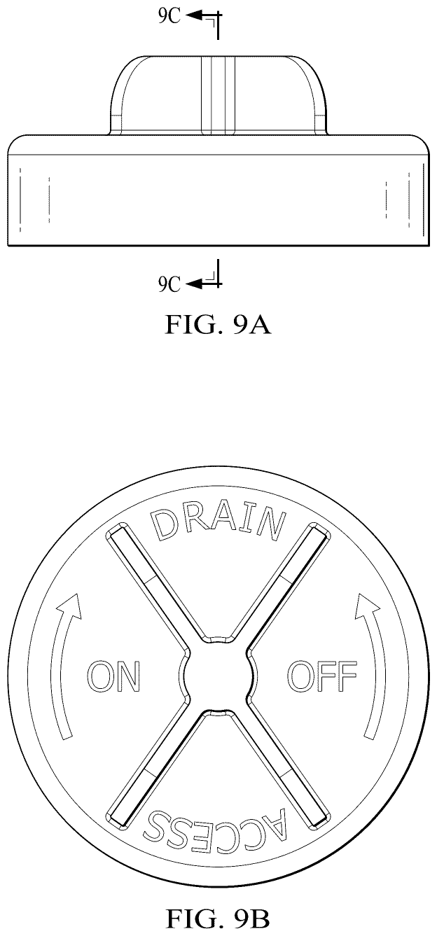

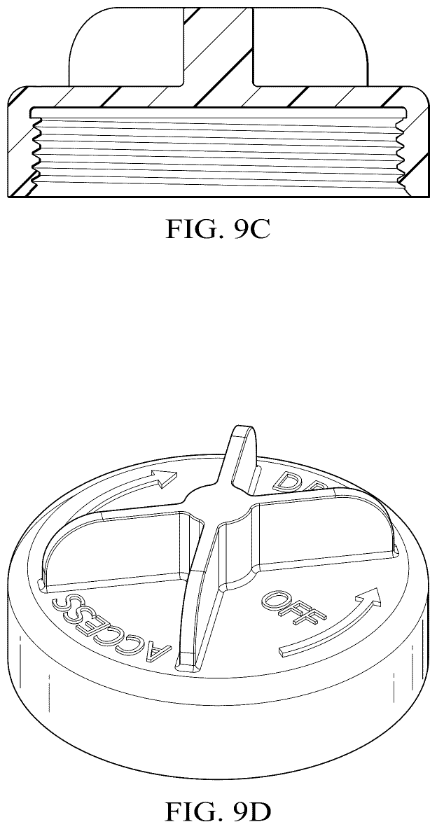

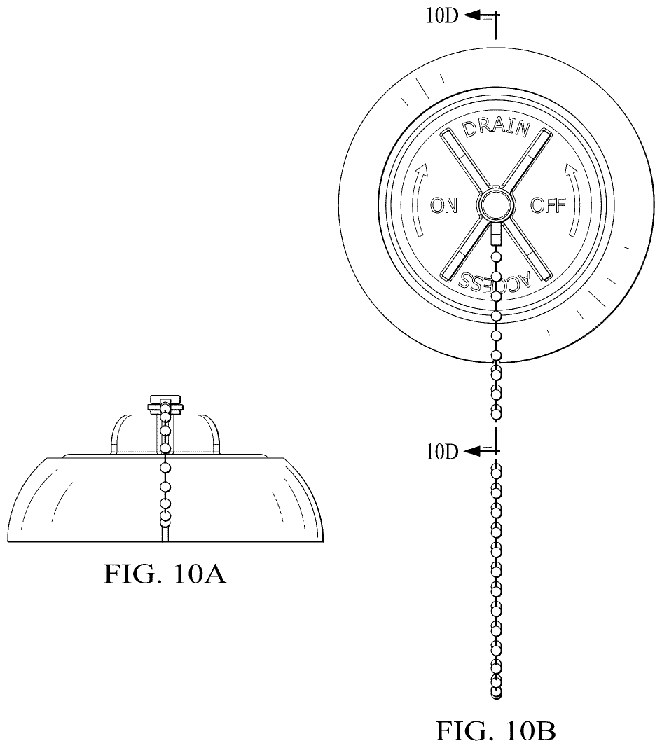

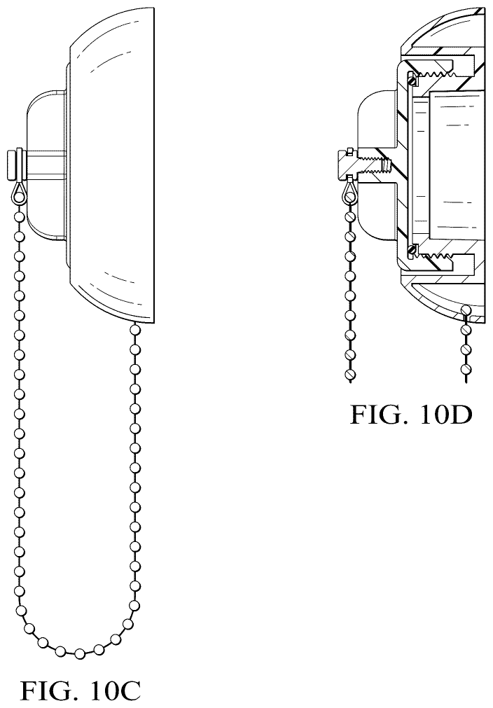

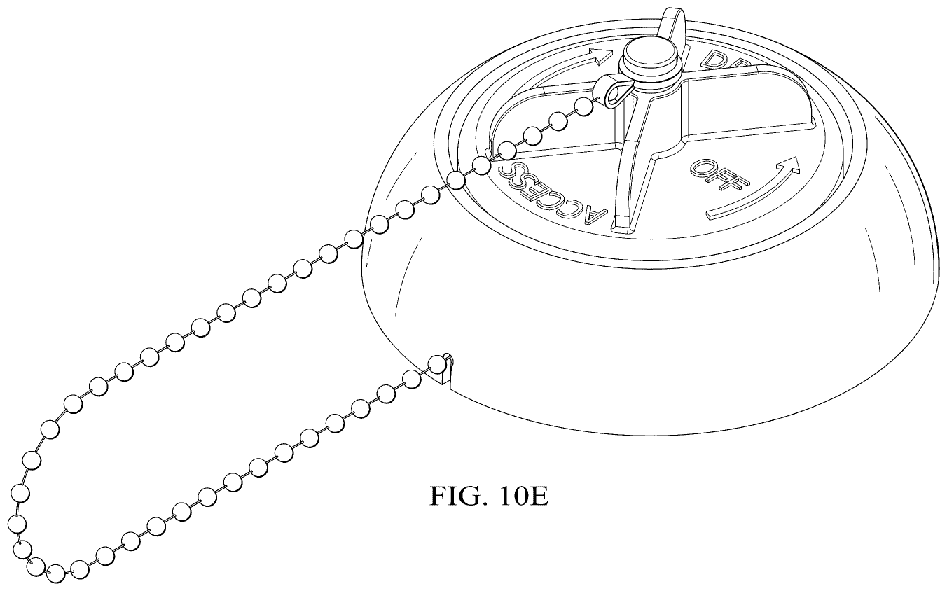

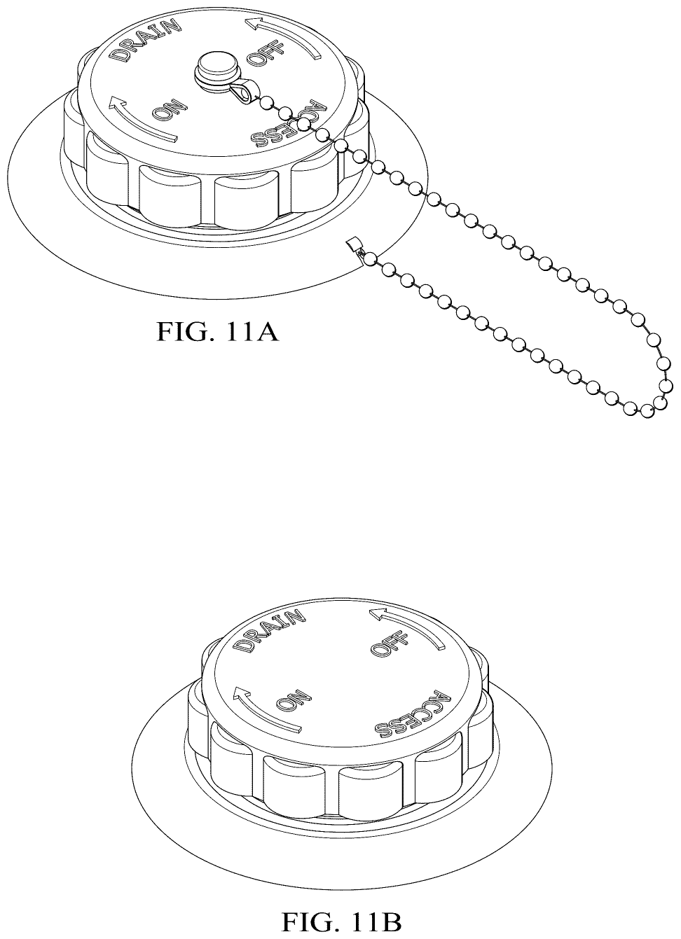

Referring now to FIGS. 4A to 11B, in some embodiments of cap of this disclosure, the cap includes a scalloped perimeter to assist with the hand-tightening and loosening. In other embodiments, the cap includes at least one flange extending perpendicular to the upper end of the cap for use in hand-tightening or loosening. The cap and its corresponding stub out fitting may each include a retention post for receiving a chain to connect the cap to the fitting when the cap is removed from the fitting.

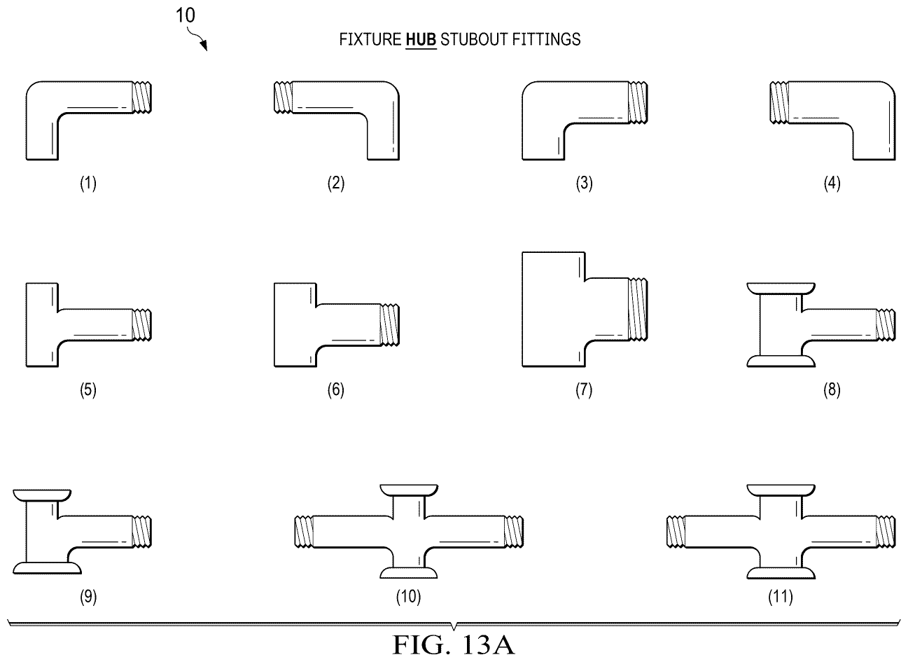

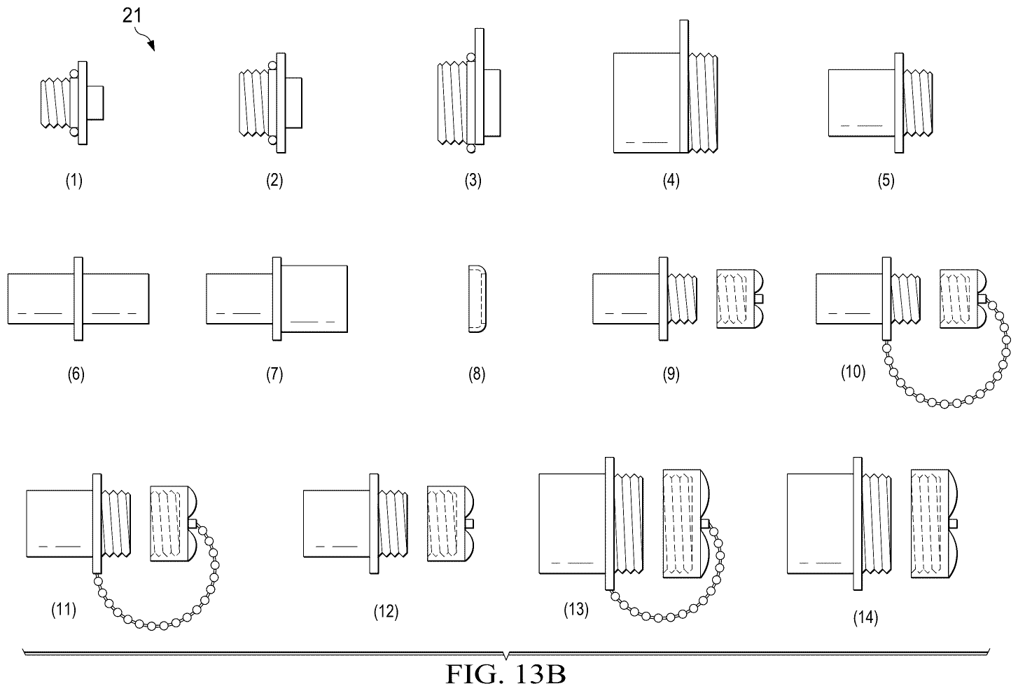

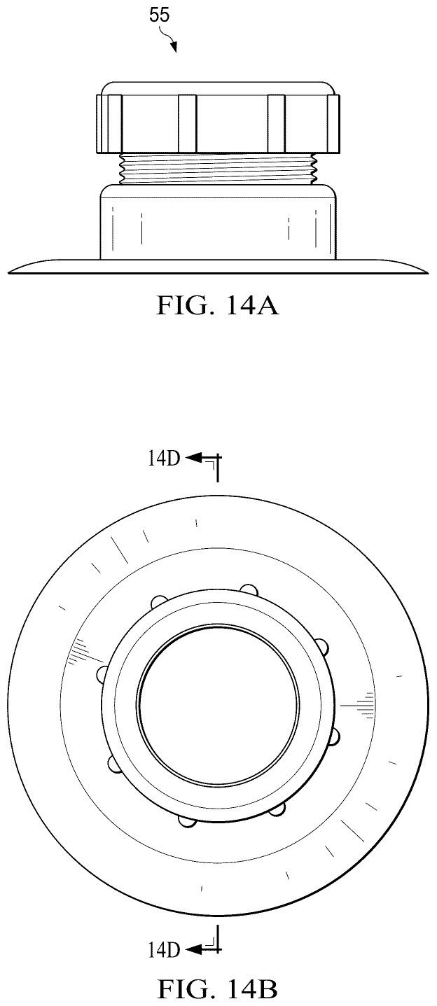

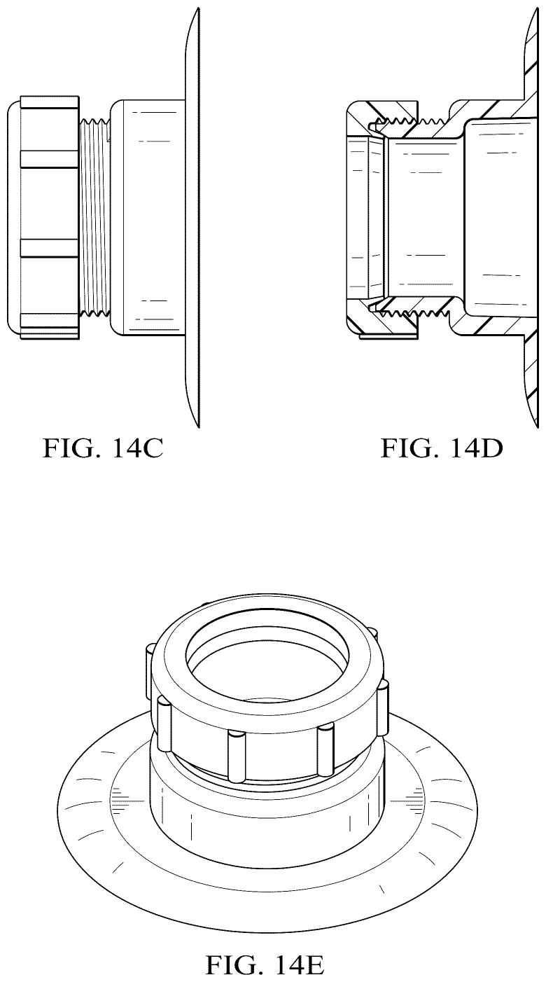

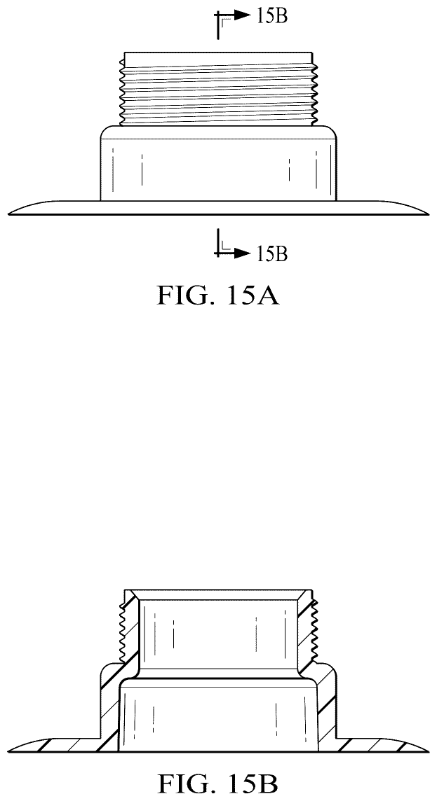

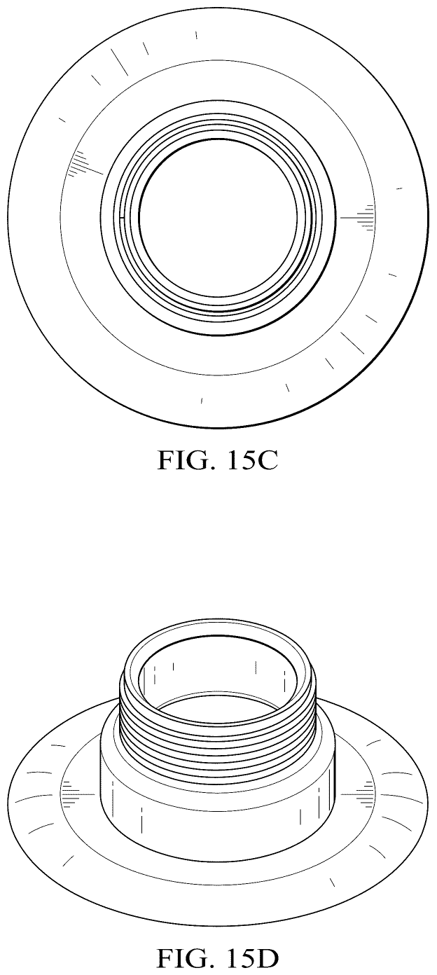

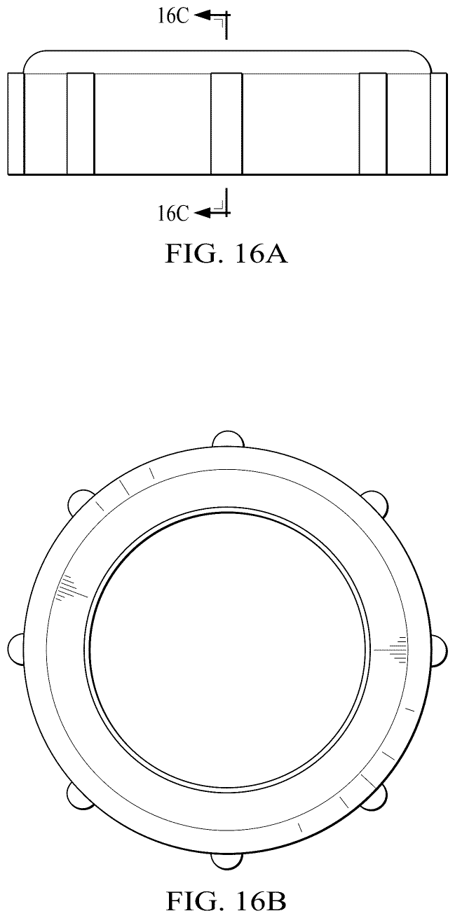

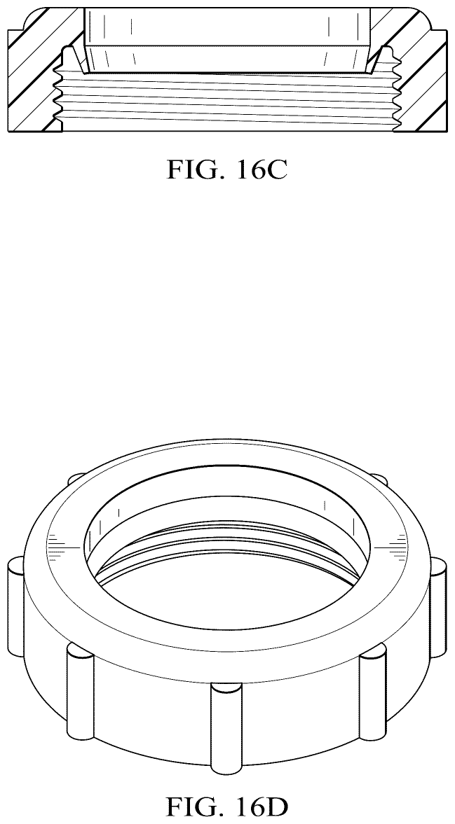

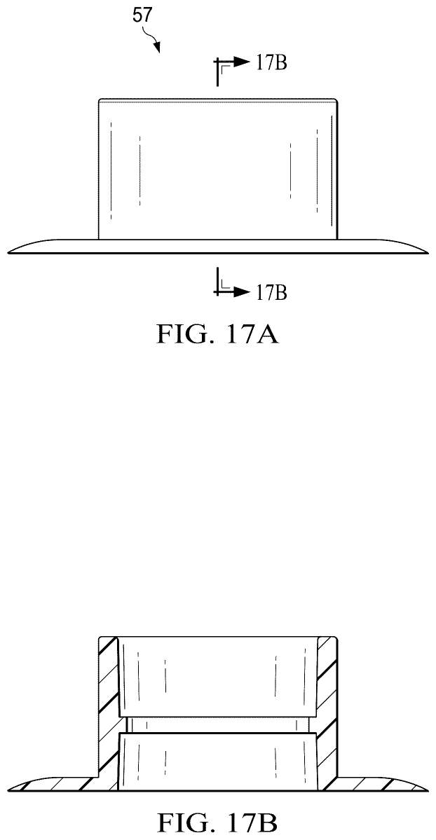

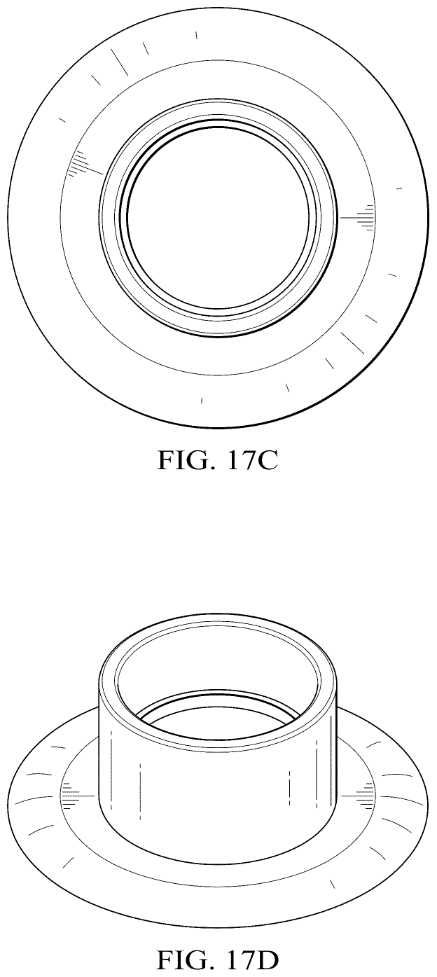

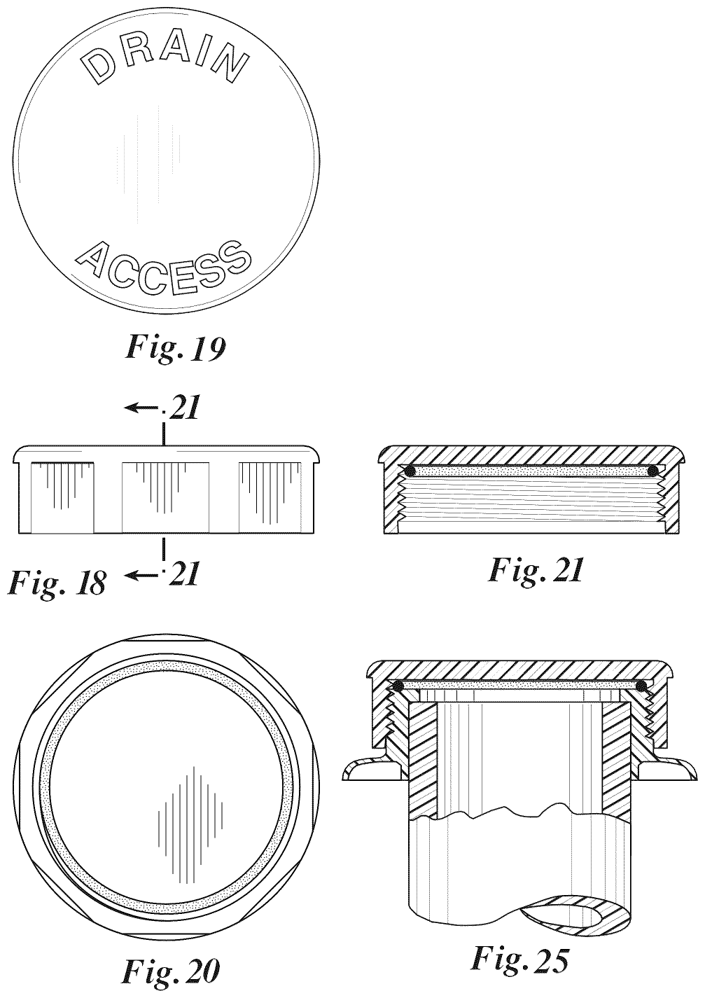

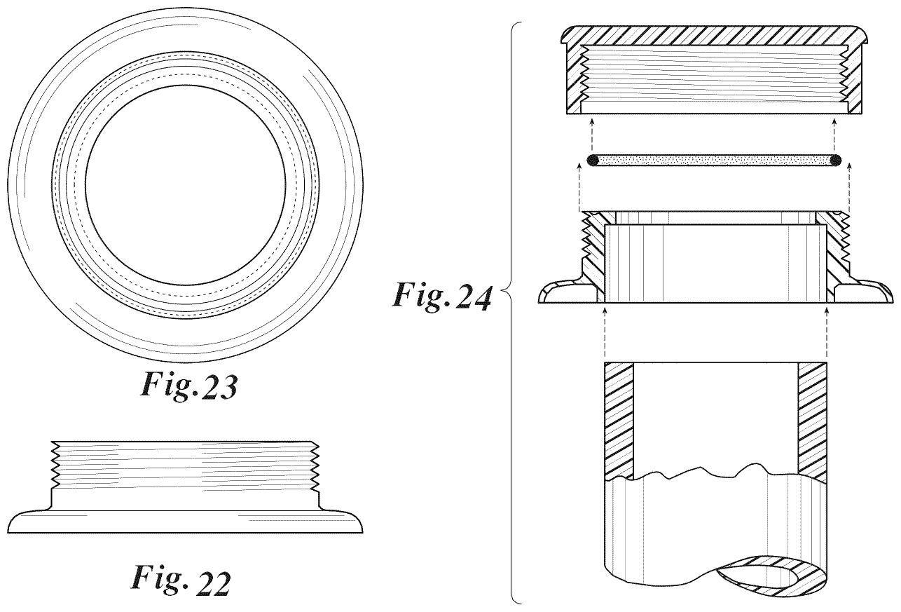

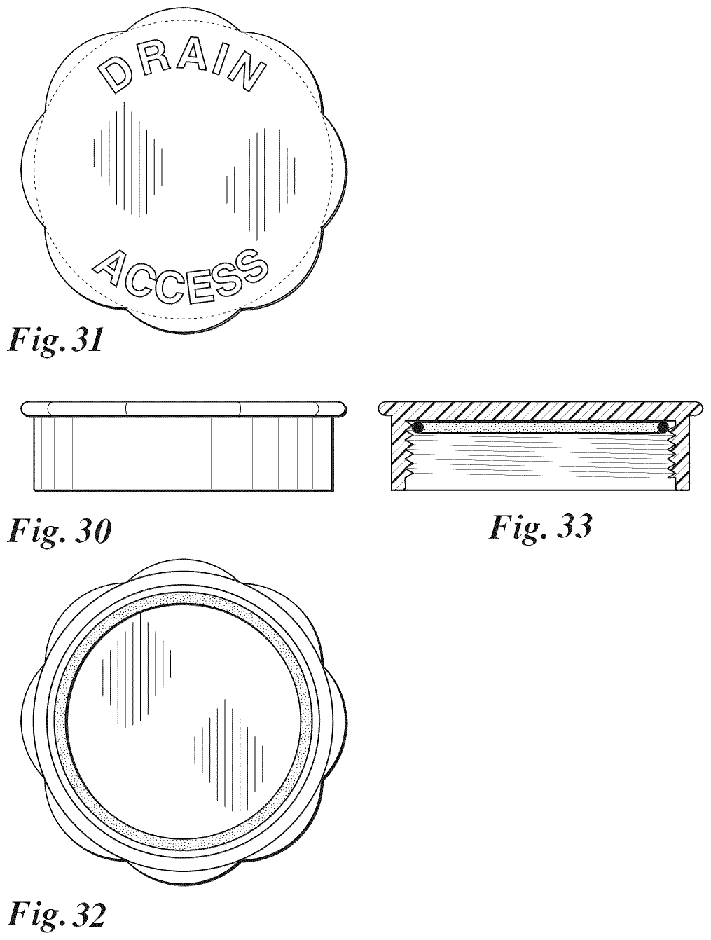

Referring to FIGS. 18 to 26 and 30 to 13, embodiments of an access fitting of this disclosure includes a coupling and a cap, the coupling adapted for connection to a pipe, the coupling including: a central passageway defining an inside diameter of the coupling; a lower end including a circumferential flange surrounding an outer wall of the coupling; and an upper end including an externally threaded surface; the cap including an O-ring and an internally threaded surface adapted for engagement with the externally threaded surface of the coupling. The circumferential flange may have a flat or arcuate profile.

In embodiments, the inner wall of the coupling may be non-threaded, adapted for slip-fit connection to a drain pipe by way of plumber's cement. The drain pipe extends outward of a planar, vertical finish, such as drywall, tile, a cabinet back, or the like. The drain pipe is then cut to length of the socket fit of the access fitting and glued on. When in an installed state, the arcuate-shaped, circumferential flange surrounds the exposed end of the drain pipe and its bottom end contacts the planar vertical finish. The cap is then hand tightened to the coupling. Unscrewing the cap provides access to the drain pipe. Any waste that escapes the now opened pipe falls outward of the planar, vertical finish.

Unlike prior art residential clean-out applications, there are no gaps around the fitting when drywalled or fitted to a cabinet back. Instead, the fitting sits flush against the finished wall or cabinetry and be caulked for proper sealing. Also, unlike the prior art clean-out or access fittings, with fittings of this disclosure there are no threads for the drain cable to drag across. Additionally, no tools will be required to remove the access fitting because it is hand tightened.

The access fitting may be made from PVC or ABS or the like. In some embodiments, the coupling and cap are 3D printed. In some embodiments the fitting may be chrome-plated or plain. When plain it can be painted to match wall décor.

An access fitting of this disclosure can be retrofitted to an existing clean-out in the recessed wall. In embodiments of a retrofit method of this disclosure, after the old plug is removed, a schedule 80 pipe nipple (or the like), having a length sufficient to extend past the finished wall or cabinet back, can be screwed into the clean-out fitting and then cut to length of the socket fit of the access fitting. The access fitting can then be glued on. In some embodiments, the access fitting may include female threads instead of a slip fit for making different retrofit options available.

Prototypes of an access fitting of this disclosure have been tested at 10-foot head pressure and have remained leak free.

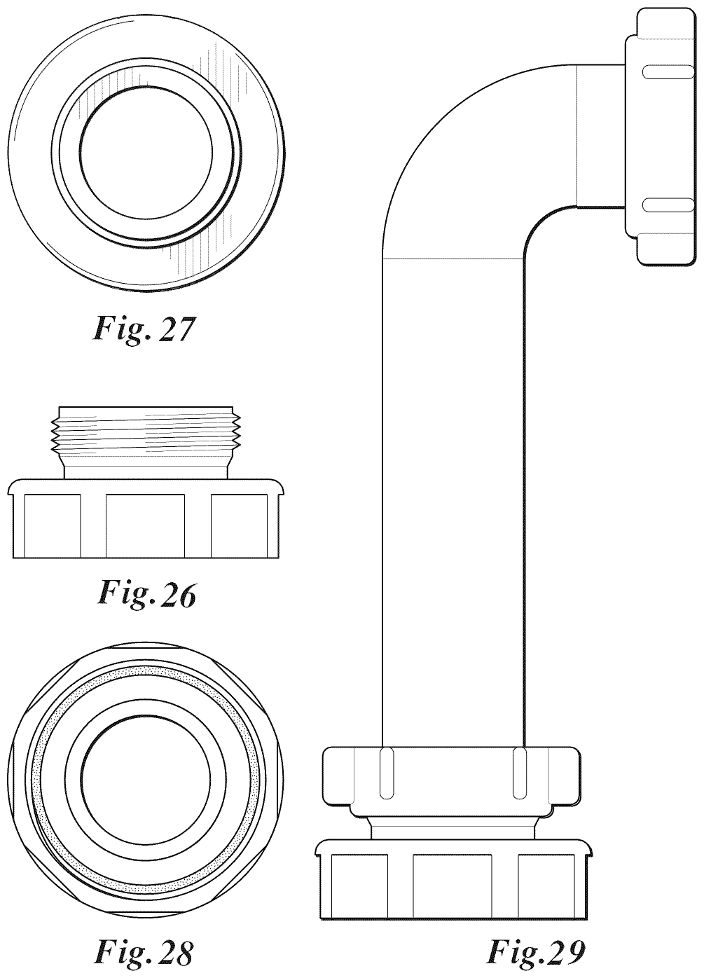

Referring now to FIGS. 26 to 29, in other embodiments of this disclosure, the fitting includes only the coupling, which is adapted for use as a trap adapter style fitting of the kind used in connection a PVC tubular p-trap and installed hand tight.

While embodiments of this disclosure have been described, the invention is defined by the scope of the following claims, the elements of which are entitled to their full range of equivalents.

1. A stub out fitting selected from group consisting of a tee, a 90, and a cross; the stub out fitting including an inlet extending about 6 inches in length, the inlet having an inlet end including female threads located on an inner wall surface of the inlet.

2. The stub out fitting of claim 1, further comprising a threaded cap adapted for engagement with the female threads, the threaded cap including an o-ring.

3. The stub out fitting of claim 1 further comprising an adapter fitting adapted for connection to the inlet end.

4. The adapter fitting of claim 3, wherein the adapter fitting has at least one unthreaded end.

5. The adapter fitting of claim 3, wherein the adapter fitting has at least one male threaded end.

6. The adapter fitting of claim 5, further comprising a female threaded cap adapted for engagement with the at least one male threaded end.

7. The adapter fitting of claim 6, further comprising a chain, the adapter fitting and the female threaded cap each including a retention post to receive a corresponding end the chain.

8. The tee of claim 1, further comprising an inlet having a larger diameter and a drain and vent having a smaller diameter, the inlet including an inner curvature connecting the larger and smaller diameters.

9. The 90 of claim 1, further comprising an outlet end and an eccentric inner diameter, wherein when the 90 is oriented in a horizontal plane, a central longitudinally extending axis of the inlet and outlet ends do not intersect one another.

10. The 90 of claim 1, wherein the 90 is configured as a right- or left-handed 90.

11. A stub out fitting including an inlet extending about 6 inches in length, the inlet having an inlet end including female threads located on an inner wall surface of the inlet, the stub out fitting further including an adapter fitting adapted for connection to the inlet end, the adapter fitting including a chain, at least one male threaded end, and a female threaded cap adapted for engagement with the at least one male threaded end, the adapter fitting and the female threaded cap each including a retention post to receive a corresponding end the chain.

12. A stub out fitting including an inlet extending about 6 inches in length, the inlet having an inlet end including female threads located on an inner wall surface of the inlet the stub out fitting being a 90 and including an outlet end and an eccentric inner diameter, wherein when the 90 is oriented in a horizontal plane, a central longitudinally extending axis of the inlet and outlet ends do not intersect one another.
